(19) United States
(12) Patent Application Publication
(10) Pub. No.: US 2007/0020554 A1
(43) Pub. Date: Jan. 25, 2007

(54) Toner process

(75) Inventors: Allan Kwok-Wai Chen, Oakville (CA); Tie Hwee Ng, Mississauga (CA); Richard P. N. Veregin, Mississauga (CA); Maria N. V. McDougall, Burlington (CA); Guerino G. Sacripante, Oakville (CA); Raj D. Patel, Oakville (CA)

Correspondence Address: Marylou J. Lavoie, Esq. LLC, 1 Banks Road, Simsbury, CT, 06070, US

(73) Assignee: Xerox Corporation

(21) Appl. No.: 11/188,543

(22) Filed: Jul. 25, 2005

(51) Int. Cl. G03G 9/08

(52) U.S. Cl. 430/137.14

(57) ABSTRACT

A dual coagulant toner process comprising adding a first component comprising an ionic salt to a latex emulsion of resin having a colorant mixed therein, to form a latex emulsion; adding a second component comprising an organo-metallic aggregating agent to the latex emulsion by agitation at a temperature above a glass transition temperature of the resin, thereby forming a product mixture; subsequently cooling the product mixture to a temperature below the glass transition temperature of the resin, in order to form toner particles; and optionally, isolating the toner particles.

### TECHNICAL FIELD

The present disclosure relates generally to toner processes and more specifically relates to aggregation processes for the preparation of toner compositions.

### BACKGROUND

In reprographic technologies, such as xerographic, electrophotographic, electrostatographic, and ionographic devices, toners with volume average diameter particle sizes of from about 9 microns to about 20 microns are effectively utilized. However, in electrostatographic or electrophotographic technologies, such as the high volume Xerox Corporation 5090 copier-duplicator, high resolution characteristics and low image noise are highly desired, and can be attained utilizing smaller sized toners having, for example, a volume average particle diameter of from about 2 to about 11 microns or less than about 7 microns, and with a narrow geometric size distribution (GSD) of from about 1.1 to about 1.3. Additionally, in xerographic systems wherein process color is utilized, such as pictorial color applications, small particle size colored toners of from about 3 to about 9 microns, are can be used to avoid or minimize paper curling. Also, select small toner particles sizes, such as from about 1 to about 7 microns, can be used and with higher colorant loading, such as from about 5 to about 12 percent by weight of toner, such that the mass of toner layers deposited onto paper is reduced to obtain the same quality of image and resulting in a thinner plastic toner layer on paper after fusing, thereby minimizing or avoiding paper curling.

Numerous processes are known for the preparation of toners, such as, for example, conventional polyester processes wherein a resin is melt kneaded or extruded with a pigment, micronized and pulverized to provide toner particles of the desired volume average particle diameter and geometric size distribution. In such processes, wherein large materials are mechanically reduced in size to achieve the desired smaller toner particles, it is usually necessary to subject the aforementioned toners to a classification procedure such that the desired size and geometric size distribution is attained. Also, in the aforementioned conventional process, low toner yields after classification may be obtained. For example, during the preparation of toners with average particle size diameters of from about 11 microns to about 15 microns, toner yields range from about 70 percent to about 85 percent after classification, and during the preparation of smaller sized toners with particle sizes of from about 7 microns to about 10 microns, lower toner yields may be obtained after classification, such as from about 50 percent to about 70 percent.

As an improvement to the foregoing mechanical reduction processes, processes are known in which the toner is achieved via aggregation as opposed to particle size reduction. For example, emulsion/aggregation/coalescing processes for the preparation of toners are illustrated in a number of Xerox patents, the disclosures of which are totally incorporated herein by reference in their entireties, such as U.S. Pat. Nos. 5,290,654, 5,278,020, 5,308,734, 5,370,963, 5,344,738, 5,403,693, 5,418,108, 5,364,729, and 5,346,797. Also of interest may be U.S. Pat. Nos. 5,348,832, 5,405,728, 5,366,841, 5,496,676, 5,527,658, 5,585,215, 5,650,255, 5,650,256, and 5,501,935, the disclosures of which are each totally incorporated by reference herein in their entireties.

Illustrated in U.S. Pat. No. 5,593,807, the disclosure of which is totally incorporated herein by reference in its entirety, is a process for the preparation of toner compositions described in the Abstract as a process for the preparation of toner compositions comprising: (i) preparing an emulsion latex comprised of sodio sulfonated polyester resin particles of from about 5 to about 500 nanometers in size diameter by heating said resin in water at a temperature of from about 65° C. to about 90° C.; (ii) preparing a pigment dispersion in a water by dispersing in water from about 10 to about 25 weight percent of sodio sulfonated polyester and from about 1 to about 5 weight percent of pigment; (iii) adding the pigment dispersion to a latex mixture comprised of sulfonated polyester resin particles in water with shearing, followed by the addition of an alkali halide in water until aggregation results as indicated by an increase in the latex viscosity of from about 2 centipoise to about 100 centipoise; (iv) heating the resulting mixture at a temperature of from about 45° C. to about 80° C. thereby causing further aggregation and enabling coalescence, resulting in toner particles of from about 4 to about 9 microns in volume average diameter and with a geometric distribution of less than about 1.3;and optionally (v) cooling the product mixture to about 25° C. and followed by washing and drying. U.S. Pat. No. 5,945,245, the disclosure of which is totally incorporated herein by reference in its entirety, describes in the Abstract a surfactant free process for the preparation of toner comprising heating a mixture of an emulsion latex, a colorant, and an organic complexing agent. Methods for forming toners by the aggregation process have included the method wherein during the aggregation step, the aggregating agent is added via a slow, steady continuous addition. U.S. Pat. No. 6,395,445, the disclosure of which is hereby totally incorporated by reference herein in its entirety, describes in the Abstract a process for forming toner particles including aggregating the toner particles by adding an aggregating agent to a latex emulsion of resin having a colorant mixed therein, the adding being done under adding conditions of agitation and a temperature above a glass transition temperature of the resin, wherein the adding of the aggregating agent comprises first introducing at least about 40% by weight of a total amount of aggregating agent to be added at a rapid introduction rate and subsequently adding a remaining portion of the aggregating agent at a continuous addition rate slower than the rapid introduction rate The particles are subsequently cooked to a temperature below the glass transition temperature of the resin when particles have been grown to the desired size.

Generally, sulfonated polyester (SPE) resins for emulsion/aggregation (EA) toner have been made by bulk polycondensation reactions in a reaction vessel followed by discharge from the reaction vessel. When the desired molecular weight/viscosity is obtained, the viscous resin is discharged into drums and cooled. The SPE resin is then crushed and milled before being dissipated into water at elevated temperatures (for example, about 80° C. to about 150° C.) to form the latex, given that the resin has sufficient sulfonated monomer to dissipate readily. The resulting latex is mixed with pigments, wax and other additives to form toner particles.

Zinc acetate is a known aggregating/coagulating agent used for in the preparation of SPE particles. The resulting toner particles provide a satisfactory particle GSD. However, the amount of zinc acetate coagulant required to generate the required particles is problematic. For example, about 15% zinc acetate by weight of toner is fed into the reactor to generate the required particles while only about 2% to about 3% by weight of toner gets incorporated while the rest remains in the aqueous phase requiring the filtrate to be cleaned and free of zinc prior to discharge such as into the sewer system. This necessitates an additional process and slows down throughput as well as increases the total toner cost. The low incorporation of zinc is believed to be primarily due to zinc's high solubility in water and the particle dissociation (pKa) of the zinc acetate. The bulk of the zinc acetate resides in the aqueous phase and is highly pH dependant. The pKa of zinc acetate is about 4.6. Reducing the pH of the media causes the pKa to shift and resulting in less zinc in the aqueous phase. Temperature also affects the content of zinc found in the aqueous phase. These considerations make particle size and GSD control quite difficult. The aqueous zinc acetate solution can be added at elevated temperature, such as for example, a temperature of about 55° C. to about 70 ° C., or about 62° C. to about 70° C. However, adding the zinc acetate at elevated temperature does not address the problem of low incorporation. Adding the zinc acetate at elevated temperature accelerates the rate of particle formation and often in an uncontrollable manner.

The appropriate components and process aspects of the each of the foregoing U.S. Patents may be selected for the present compositions and processes in embodiments thereof.

There remains a need for an improved process for forming toner particles in order to improve economic feasibility, increase ability to achieve desired GSD more economically, improve incorporation of the aggregating agent into the toner particle, reduce process complexity, achieve less fouling and reduce or eliminate the need for cleaning steps currently required to avoid contamination of the environment by species (zinc) in the discharge filtrate.

### SUMMARY

Aspects illustrated herein relate to a dual coagulant toner process comprising adding a first component comprising an ionic salt to a latex emulsion of resin having a colorant mixed therein, to form a latex emulsion; adding a second component comprising an organo-metallic aggregating agent to the latex emulsion by agitation at a temperature above a glass transition temperature of the resin, thereby forming a product mixture; subsequently cooling the product mixture to a temperature below the glass transition temperature of the resin, in order to form toner particles; and optionally, isolating the toner particles.

Aspects illustrated herein further relate to a single coagulant toner process comprising (i) heating a resin in water at a temperature above a glass transition temperature of the resin to form a latex emulsion of resin; (ii) providing a colorant dispersion or preparing a colorant dispersion by dispersing a colorant in water to form a colorant dispersion; (iii) adding the colorant dispersion of (ii) to the latex emulsion of (i) with agitation to form particles; (iv) growing particles formed in (iii) at an elevated temperature, and adding a single coagulating/aggregating component comprising an ionic salt by agitation during the growing to form a product mixture; (v) subsequently cooling the product mixture obtained to a temperature below the glass transition temperature of the resin to form toner particles; and (vi) optionally, isolating the toner particles. Elevated temperature as used means a temperature above room ambient temperature. For example, elevated temperature comprises, in embodiments, a temperature above the glass transition temperature of the resin.

Aspects related herein further related to a dual coagulant toner process comprising adding an organo-metallic aggregating agent to a latex emulsion of polyester resin having a colorant mixed therein to form a polyester latex emulsion; adding an ionic salt to the polyester latex emulsion by agitating at a temperature above a glass transition temperature of the polyester resin to form a product mixture; subsequently cooling said product mixture to a temperature below the glass transition temperature of the polyester resin to form toner particles; and optionally, isolating the toner particles.

The present toner processes provide having many of the advantages illustrated herein. For example, for the duel coagulant system, there is no detrimental charging effect observed when greater than about 0.03% ionic salt, for example divalent salt such as calcium chloride (about 300 parts per million), based upon the total weight of the toner, is provided as the aggregating agent.

These and other features and advantages will be more fully understood from the following description of certain specific embodiments taken together with the accompanying claims.

### DESCRIPTION

A toner process is provided employing a dual coagulant system including a first component comprising an ionic salt and a second component comprising an organo-metallic aggregating agent. For example, a dual coagulant system as used herein can comprise a first component comprising an ionic salt, for example, any suitable ionic salt, such as a divalent salt, including but not limited to, sulfates, phosphates, and chlorides of zinc, calcium, aluminum, barium cesium, sodium, zirconium, and mixtures thereof, and a second component comprising an organo-metallic aggregating agent such as, for example, any suitable organo-metallic aggregating agent, such as zinc acetate. Additional examples of suitable organo-metallic aggregating agents for the second component include, but are not limited to, for example, organo-metallic aggregating agent selected from the group consisting of magnesium acetate, strontium acetate, vanadium acetate, niobium acetate, tantalum acetate, chromium acetate, molybdenum acetate, tungsten acetate, manganese acetate, iron acetate, ruthenium acetate, cobalt acetate, nickel acetate, copper acetate, zinc acetate, cadmium acetate, silver acetate, aluminum acetate, vanadium acetoacetate, niobium acetoacetate, tantalum acetoacetate, chromium acetoacetate, molybdenum acetoacetate, tungsten acetoacetate, manganese acetoacetate, iron acetoacetate, ruthenium acetoacetate , cobalt acetoacetate, nickel acetoacetate, copper acetoacetate, zinc acetoacetate, cadmium acetoacetate, silver acetoacetate, aluminum acetoacetate, and mixtures and combinations thereof The dual coagulant system coagulation process achieves a desired toner charge characteristic and without adding costs or requiring modifications to the toner formulation and wherein RH (relative humidity) sensitivity issues are avoided.

Further provided is a toner process employing a single coagulant system comprising an ionic salt, such as a divalent salt, for example, calcium chloride, as a coagulant/aggregating agent prior to a particle growing step in the absence of an organo-metallic aggregating agent, such as zinc acetate, to prepare toner particles, such as emulsion aggregation sulfonated polyester particles. The ionic salt can be selected, for example, from a divalent salt, including but not limited to, sulfates, phosphates, and chlorides of zinc, calcium, aluminum, barium, cesium, sodium, zirconium, and mixtures and combinations thereof. The single coagulant ionic salt system overcomes or alleviates the issues of residual zinc in the filtrate that is experienced with current processes using zinc acetate. The amount of ionic salt required is less than the current amounts of zinc acetate coagulant required to achieve similar particle size and GSD. For example, about one third the amount of ionic salt, such as a divalent salt, compared to the amount of zinc acetate can be used to achieve a similar particle size and GSD product. Further, the process increases the amount of coagulant incorporated into the toner particle over processes employing zinc acetate. For example, the amount of incorporation of ionic salt into the toner particle can be greater than about 50%. While not wishing to be bound by theory, for example, calcium chloride is soluble in water, but not as highly soluble as zinc acetate. Therefore, the pKa equilibrium between the solid and aqueous phase is quite different for calcium chloride than it is for zinc acetate, leaning more toward the solid phase than zinc acetate thereby improving incorporation and reducing waste contamination issues. For example, in embodiments an about 4% calcium chloride solution added at the beginning of the toner process prior to a particle growing step can generate about 5.5 micron pigmented sulfonated polyester resins particles with a narrow GSD.

The present disclosure is directed to toner processes and more specifically to aggregation processes for the preparation of toner compositions such as polyester resin compositions, for example, in embodiments, sulfonated polyester resin compositions. Dual coagulant and single coagulant toner processes are provided. In embodiments, the disclosure is directed to the economical an environmentally advantageous in situ preparation of toners without known pulverization and/or classification methods, and wherein in embodiments toner compositions with a volume average diameter of about 1 to about 15 microns, or about 1 to about 10 microns, or about 3 to about 8 microns, and a narrow GSD of, for example, about 1.10 to about 1.25, or about 1.10 to about 1.20 as measured on a Coulter Counter.

The resulting toners can be selected for known electrophotographic imaging, digital, printing processes, including color processes, and lithography. For example, imaging processes are selected comprising developing an image on a photoreceptor with a toner composition prepared by the dual coagulant toner process or the single coagulant toner process. Further provided are imaging processes comprising preparing an image with a xerographic device comprising a charging component, an imaging component, a photoconductive component, a developing component, a transfer component, and a fusing component; wherein the development component comprises a developer prepared by mixing a carrier with a toner composition prepared with the dual coagulant toner process or the single coagulant toner process.

A toner process employing a dual coagulant system comprises aggregating toner particles by adding a first component comprising an ionic salt, for example a divalent salt, optionally in an amount of about 0.01% to about 5%, or about 0.01% to about 0.1%, by weight based upon the total weight of the toner, to a latex emulsion of resin having a colorant mixed therein prior to a particle growing step; performing a particle growing step comprising adding a second component comprising an organo-metallic aggregating agent, for example zinc acetate, to the latex emulsion of resin, the adding being done under adding conditions of agitation at a temperature above a glass transition temperature of the resin; subsequently cooling a product mixture obtained to a temperature below the glass transition temperature of the resin; and wherein the resin is a polyester resin. The toner particles can be subsequently collected.

In the dual coagulant process, the first aggregating component in the form of an ionic salt, for example a divalent salt such as calcium chloride, is added to a mixture of a latex emulsion of the toner binder resin and a colorant dispersion, the ionic salt being selected in a small quantity, that is a quantity sufficient to have a desired effect on toner charge without causing deterioration in particle growth, such as in an amount of about 0.01% to about 5%, or about 0.01% to about 0.1%, by weight based upon the total weight of the toner, prior to the particle growing step. The ionic salt can be selected, for example, from sulfate ionic salts, phosphate ionic salts, and chloride ionic salts, including, but not limited to, zinc sulfate, calcium sulfate, aluminum sulfate, barium sulfate, cesium sulfate, sodium sulfate, zirconium sulfate, zinc phosphate, calcium phosphate, aluminum phosphate, barium phosphate, cesium phosphate, sodium phosphate, zirconium phosphate, zinc chloride, calcium chloride, aluminum chloride, barium chloride, cesium chloride, sodium chloride, zirconium chloride, and mixtures and combinations thereof

In an alternate embodiment, a dual coagulant toner process comprises adding an organo-metallic aggregating agent to a latex emulsion of resin having a colorant mixed therein prior to a particle growing step; performing a particle growing step comprising adding an ionic salt to the latex emulsion of resin, the adding being done under adding conditions of agitation at a temperature above a glass transition temperature of the resin; subsequently cooling a product mixture obtained to a temperature below the glass transition temperature of the resin; optionally, isolating the toner particles; and wherein the resin is a polyester resin.

The latex emulsion of binder resin may be formed by forming a latex of a polyester, such as a sodium sulfonated polyester, resin in water with heating the resin in water at a temperature of about, for example 45° C. to about 90° C. The polyester resin selected preferably contains sulfonated groups thereby rendering them dissipatable, that is, they form spontaneous emulsions in water without the use of organic solvents, especially above the glass transition temperature, Tg, of the polyester resin. The latex of suspended polyester resin particles is comprised of particles which have an average size of, for example, about 5 nanometers (nm) to about 500 nm or about 10 nm to about 250 nm in volume average diameter as measured by any suitable device such as, for example, a NiComp sizer. The polyester particles comprise, for example, about 5 to about 40 percent by weight of the latex emulsion.

The polyester, such as sulfonated polyester, may be formed from any suitable acid and alcohol. For example, the polyester can be derived from one or more terephthalates and one or more glycols. For example, the polyester may be derived from a reaction that includes, for example, three glycol components. In embodiments, the polyester is a sulfonated polyester derived from a reaction of dimethylterephthalate, sodium dimethyl 5-sulfoisophthalate, propanediol, diethylene glycol and diproplyene glycol.

Additional examples of sulfonated polyesters which may be used in the present process include those illustrated in U.S. Pat. Nos. 5,593,807 and 5,945,245, the disclosures of each of which are totally incorporated herein by reference, for example including sodium sulfonated polyester, and more specifically, a polyester such as poly(1,2-propylene-sodio-5-sulfoisophthalate), poly(neopentylene-sodio-5-sulfoisophthalate), poly(diethylene-sodio-5-sulfoisophthalate), copoly(1,2-propylene-sodio-5-sulfoisophthalate)-copoly-(1,2-propylene-terephthalate-phthalate), copoly(1,2-propylene-diethylene-sodio-5-sulfoisophthalate)-copoly-(1,2-propylene-diethylene-terephthalate-phthalate), copoly(ethylene-neopentylene-sodio-5-sulfoisophthalate)-copoly-(ethylene-neopentylene-terephthalate-phthalate), and copoly(propoxylated bisphenol A)-copoly-(propoxylated bisphenol A-sodio-5-sulfoisophthalate).

The sulfonated polyesters may in embodiments be represented by the following formula or random copolymers thereof wherein the n and p segments are separated.

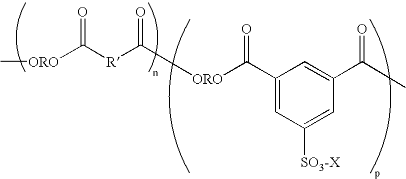

where R is an alkylene of, for example, from about 2 to about 25 carbon atoms such as ethylene, propylene, butylenes, oxyalkylene diethyleneoxide, and the like; R'is an arylene of, for example, about 6 to about 36 carbon atoms, such as a benzylene, bisphenylene, bis(alkyloxy)bisphenolene, and the like; p and n represent the number of randomly repeating segments, such as for example, about 10 to about 10,000, and X is lithium or sodium. The alkali sulfopolyester possess, for example, a number average molecular weight (Mn) of about 1,500 to about 50,000 grams per mold and a weight average molecular weight (Mw) of from about 6,000 grams per mole to about 150,000 grams per mole as measured by gel permeation chromatography and using polystyrene as standards.

To this latex emulsion of binder is added, with controlled agitation/mixing, a colorant such as a colorant dispersion containing, for example, about 5 to about 50 percent of predispersed colorant in water. The colorant may be, for example, dyes, pigments, mixtures thereof, mixtures of pigments, mixtures of dyes, mixtures of pigments and dyes, and the like, and in embodiments, pigment mixtures can be used. The colorant may have a color of, for example, black (e.g., carbon black), cyan, yellow, magenta, or mixtures thereof The colorant can have a mean colorant size ranging from about 50 nanometers to about 150 nanometers.

These colorants, especially pigments, can be selected in various effective amounts, generally about 1 weight percent to about 65 weight percent or about 2 weight percent to about 12 weight percent, of the toner. Various known colorants or pigments can be selected. A suitable black pigment that may be used is, for example, carbon black such as REGAL 330™, and the like. As colored pigments, there can be selected pigments of cyan, magenta, yellow, red, green, brown, blue or mixtures thereof Specific examples of pigments include phthalocyanine HELIOGEN BLUE L6900™, D6840™, D7080™, D7020™, PYLAM OIL BLUE™, PYLAM OIL YELLOWM™, PIGMENT BLUE 1™available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & company, and the like. Examples of magenta are 2,9-dimethyl-substituted quinacridone and anthraquinone dye identified in the Color Index as CI 60710, CI Dispersed Red 15, diazo dye identified in the Color Index as C126050, CI Solvent Red 19, and the like. Illustrative examples of cyans include copper tetra(octadecyl sulfonamide) phthalocyanine, x-copper phthalocyanine pigment listed in the Color Index as CI 74160, CI Pigment Blue, and Anthrathrene Blue, identified in the Color Index as CI 69810, Special Blue X-2137, and the like; while illustrative examples of yellows that may be selected are diarylide yellow 3,3-dichlorobenzidene acetoacetanilides, a monoazo pigment identified in the Color Index as CI 12700, CI Solvent Yellow 16, a nitrophenyl amine sulfonami identified in the Color Index as Foron Yellow SE/GLN, CI Dispersed Yellow 33 2,5-dimethoxy-4-sulfonailide phenylazo-4'-chloro-2,5-dimethoxy acetoanilide, and Permanent Yellow FGL.

In embodiments, the colorant is comprised of a predispersed pigment such as are commercially available. Although dry pigments may be used, additional processing requirements, for example including the use of a homogenizer, may be needed in forming the toner. The use of predispersed pigment dispersions avoids the need for such additional processing requirements. Examples of pigment dispersions include, for example, the FLEXIVERSE™ series and SUNSPERSE™ series of pigment dispersions from Sun Chemical. Some of these are Blue 15:3 (BFD-1121), Blue 15 (BFD-1149), Blue 61 (BFD-9516), Red 81:2 (RFD 964), Red 22 (RFD-4241), Yellow 14 (YFD-1123), Yellow 17 (YFD-4249), Black Regal 660 (LFD4343), Green 7 (GFD1151), Green 36 (GHD-7114), Violet 19 (QFD-1180) and Violet 23 (VFD-1157).

In the present dual coagulant process, the first component comprising an ionic salt is added to the latex emulsion of resin having a colorant mixed therein prior to a particle growing step. For example, once the colorant dispersion has been added to the latex emulsion of resin, an initial small amount of the first component comprising an ionic salt, is introduced into the mixture in an amount selected sufficient to effect toner charge without causing deterioration in particle growth, such as in an amount of about 0.01% to about 5%, or about 0.01% to about 0.1%, by weight based upon the total weight of the toner, prior to a particle growing step.

Following, a particle growing step comprises adding a second component comprising an organo-metallic aggregating agent, for example zinc acetate, to the latex emulsion of resin, the adding being done under adding conditions of agitation at a temperature above a glass transition temperature of the resin; subsequently cooling a product mixture obtained to a temperature below the glass transition temperature of the resin.

The adding of the first and second coagulant/aggregating components can be conducted under conditions of agitation and a temperature above a glass transition temperature of the resin. The agitation is performed, for example, by stirring or shearing effected by use of stirring impeller (agitator) blades in the reaction vessel. The temperature is achieved by heating to a temperature above the glass transition of the resin. For example, the temperature can be selected at about 10° C. to about 40° C. above the glass transition temperature of the resin. For sodium sulfonated polyester resins, the temperature is, for example, about 45° C. to about 100° C.

The second aggregating component comprising an organo-metallic aggregating agent is added into the mixture in the particle growing step. Optionally, the second aggregating agent can be added in two distinct phases, reference for example U.S. Pat. No. 6,395,445, the disclosure of which is totally incorporated by reference herein.

In embodiments, the first component and second component in the dual coagulant system are added as a solution in water. For example, the first component comprising an ionic salt, can be selected in an amount of from about 0.01% to about 5%, or from about 0.01% to about 0.1%, by weight based upon the total weight of the toner. The ionic salt can be provided as a solution, for example, the ionic salt can be provided as a 1% calcium chloride in water. The water, in embodiments, is deionized water. The second component comprising an organo-metallic aggregating agent, can be selected, for example, in an amount of about 1% to about 20%, or about 3% to about 15%, by weight based upon the total weight of the toner, and can be provided as a solution comprising, for example, about 0.5% to about 5% zinc acetate in water, wherein the water can be deionized water.

In another embodiment, a release agent can optionally be used wherein the release agent is a wax and wherein the wax is an alkylene wax, a polyethylene wax, polypropylene wax, a paraffin wax, a microcrystalline wax, a Fischer-Tropsch wax or mixtures thereof.

Addition of the second component comprising an organo-metallic aggregating agent, such as zinc acetate, causes complexion between the Zn²⁺ ions and the SO³⁻ ions on the resin. The close contact, temperature and ionic strength of the media cause the particles to aggregate into larger particles. Particle growth stops by cooling the slurry to a temperature below the resin Tg.

Any other suitable aggregating agent capable of causing complexation as discussed above might also suitably be used in the dual coagulant process as the second component, including, but not limited to, for example, alkali earth metal salt organo-metallic aggregating agents and transition metal salt organo-metallic aggregating agents. For example, the second component can be selected from an organo-metallic aggregating agent selected from the group consisting of magnesium acetate, strontium acetate, vanadium acetate, niobium acetate, tantalum acetate, chromium acetate, molybdenum acetate, tungsten acetate, manganese acetate, iron acetate, ruthenium acetate, cobalt acetate, nickel acetate, copper acetate, zinc acetate, cadmium acetate, silver acetate, aluminum acetate, vanadium acetoacetate, niobium acetoacetate, tantalum acetoacetate, chromium acetoacetate, molybdenum acetoacetate, tungsten acetoacetate, manganese acetoacetate, iron acetoacetate , ruthenium acetoacetate, cobalt acetoacetate, nickel acetoacetate, copper acetoacetate, zinc acetoacetate, cadmium acetoacetate, silver acetoacetate, aluminum acetoacetate, and mixtures and combinations thereof.

The processes disclosed herein generate toner size particles with, for example, an average particle volume diameter of about 1 to about 15 or about 3 to about 8 microns as determined by, for example, a Coulter Counter. It is believed that during the heating, the components of the sulfonated polyester latex and the colorant dispersion aggregate and fuse together to form composite toner particles. The size of the particles can be controlled by, for example, the amount of aggregating agent added and by the temperature of heating.

Following the addition of all of the second aggregating agent into the vessel, the growth step conditions (stirring and heating) may be continued for a period of time until toner particles of the desired size and size distribution are obtained. The size may be monitored by taking samples from the vessel and evaluating the size of the toner particles, for example with a Coulter Counter.

The particles obtained after the aggregation/particle growing step can be subjected to washing/rinsing with, for example, water to remove residual aggregating agent, and drying, whereby there are obtained toner particles comprised of resin and colorant. In addition, the toner particles may be subjected to screening and/or filtration steps to remove undesired coarse particles from the toner.

Further provided are single coagulant system toner processes for forming toner particles comprising (i) providing a latex emulsion or preparing a latex emulsion of resin particles by heating the resin in water at a temperature above a glass transition temperature of the resin; (ii) providing a colorant dispersion or preparing a colorant dispersion by dispersing a colorant in water; (iii) adding the colorant dispersion to the latex emulsion with agitation; (iv) adding an aggregating agent comprising an ionic salt to the latex emulsion having a colorant dispersion added therein during a particle growing step or optionally during a washing step, the adding being done under adding conditions of agitation at a temperature above a glass transition temperature of the resin; (iv) performing a particle growing step; (v) subsequently cooling a product mixture obtained to a temperature below the glass transition temperature of the resin; and wherein the resin is a polyester resin. For example, following the addition of the second component, the adding conditions are continued until toner particles of a desired aggregation are obtained.

In the toner process comprising a single coagulant system (without the presence of other aggregating agent such as zinc acetate), the ionic salt can be selected from the ionic salts described herein above for the dual coagulant process. For example, the ionic salt aggregating agent can be selected as an ionic salt solution, for example a calcium chloride solution, for example, in an amount of from about 0.01% to about 10%, or from about 1% to about 6%, or from about 2% to about 4%, by weight based upon the total weight of the toner. In another particular embodiment, a 3% calcium chloride solution is used as the single aggregating agent. In yet another embodiment, the single aggregating agent can be added in two phases, reference for example, U.S. Pat. No. 6,395,445, the disclosure of which is totally incorporated by reference herein in its entirety. Further, a reaction temperature of about 55° C. to 65C°, a reaction pressure of atmosphere, and an agitation rate of about 300 rpm with for example two impellers, can be selected.

Surface additives may be added to the toner particles after isolation by, for example, filtration, and then optionally followed by washing and drying. Suitable external surface additives include, for example, metal salts, metals salts of fatty acids, colloidal silica, titanium oxides, mixtures thereof, and the like, which additives are usually present in an amount of about 0.1 to about 2 weight percent, reference U.S. Pat. Nos. 3,590,000; 3,720,617; 3,655,374; and 3,983,045, the disclosures of each of which are totally incorporated herein by reference. Specific additives include, but are not limited to, for example, zinc stearate, silica, such as AEROSIL R972®, and other silica available from Cabot Corporation Degussa Company. These additives can be selected in amounts of, for example, from about 0.1 to about 2 percent, and can be incorporated during the aggregation or blended into the formed toner product. The toner may also include known charge additives in effective amounts of, for example, from about 0.1 to about 5 weight percent, such alkyl pyridinium halides, bisulfates, the charge control additives of U.S. Pat. Nos. 3,944,492; 4,007,293; 4,079,014; 4,394,430; and 4,560,635, the disclosures of each of which are hereby totally incorporated by reference herein, negative charge enhancing additives like aluminum complexes, and the like. Other known positive and negative enhancing charge additives may also be selected.

The process can be used to produce toner particles with any sized reactor, and is thus commercially significant. Scaling up of the process from bench reactors to larger reactors can be readily achieved by practitioners in the art. One scale-up guide is based upon matching the power/volume requirements for the two reactors. Such a scale-up guide effectively predicts the required agitation rate even when using different impellers or different number of impellers.

The toner processes comprising a dual coagulant system or a single coagulant system provided many advantages. For example, the dual coagulant system toner process provides a toner having desired charging characteristics without adding fabrication costs or complexity. Advantages further include, for example, using calcium chloride prior to a particle growing step, selected, for example, at about 0.1% to about 4% calcium chloride by weight based upon the weight of the toner, and a second coagulant comprising an organo-metallic aggregating agent, for example, zinc acetate selected, for example, in an amount of from about 1% to about 20%, or from about 3% to aboutl 5% zinc acetate by weight based upon the weight of the toner, to achieve a comparable amount of zinc incorporation into the toner, for example, about 2 percent to about 3 percent incorporation, as previously available, but with the reduction or elimination of waste thereby reducing or eliminating the need for the washing process. Further, as the temperature is raised, for example from about 62° C. to about 70° C., the equilibrium of zinc acetate is shifted toward the particle phase. Therefore, in embodiments, the zinc acetate solution is added at an elevated temperature, for example, above about 62° C., to prevent a sudden growth in particle size such as would occur if the coagulant were added at room temperature.

Further, for example, the single coagulant system toner process has many advantages for the aggregation of polyester particles by employing an ionic salt such as calcium chloride prior to a particle growing step and by employing an ionic salt during the particle growing step as the single coagulant. Using the ionic salt provides the advantage of reducing the total amount of coagulant usage as well as increasing the incorporation of the metal ion in the toner particle as compared to known coagulant processes using zinc acetate. For example, for current zinc acetate toner processes wherein about 15 percent zinc acetate by weight of toner is used to generate the desired toner particles, only about 2 percent to about 3 percent of the total amount of zinc acetate fed into the reactor gets incorporated into the toner particle with the rest remaining in the aqueous phase thereby requiring treatment of the filtrate/waster water to remove the heavy metal ions prior to release into the sewer system. It is estimated that about 70 percent to about 80 percent of the zinc acetate is unused and wasted. This is believed to be because zinc acetate is highly soluble in water and so most of it is found to be associated in the aqueous phase. The present process reduces the amount of coagulant used and reduces or eliminates the need for filtrate/waste water treatment thereby reducing overall cost of toner fabrication.

A further advantage of the single coagulant process results in that using calcium chloride as a coagulant provides increased effectiveness and cost reduction since less calcium chloride is required as compared to zinc acetate to achieve a similar incorporation. For example, an ionic salt such as calcium chloride can be selected in an amount such as from about 0.01% to about 0.10%, or from about 1 % to about 6%, or from about 2% to about 4%, or about 0.03% of calcium chloride, by weight based upon the total weight of the toner, without adverse effect on the toner charge characteristics.

Developer compositions can be prepared by mixing the toners obtained with the dual coagulant process or the single coagulant process with known carrier particles, including coated carriers, such as steel, ferrites, and the like, reference U.S. Pat. Nos. 4,937,166 and 4,935,326, the disclosures of each of which are totally incorporated herein by reference, for example, from about 2 percent toner concentration to about 15 percent toner concentration. The carrier particles may also be comprised of a carrier core with a polymer coating, or coatings, thereover, and dispersed therein a conductive component like a conductive carbon black in an amount, for example, of about 5 to about 60 weight percent.

The following examples are set forth as representative of the present process. These examples are not to be construed as limiting the scope of the disclosure as these and other equivalent embodiments will be apparent in view of the present disclosure and accompanying claims.

### EXAMPLES

### Example 1

Single Coagulant System Toner Process

Preparation of sulfonated polyester emulsion (SPE).

Sulfonated polyester resin containing 3.75 moles of sulfonation was prepared by polycondensation reaction. The resin was ground into powder by milling. An amount of 110 grams of the resin powder was added to 10 liters of water in a reactor and stirred at a speed of 500 revolutions per minute (rpm) with a pitch blade turbine. The temperature of the reactor was raised to 85° C. and allowed to stir for a period of about 1 hour in order to dissipate the resin into an emulsion comprising about 25 nanometer sulfonated polyester (SPE) resin particles suspended in water. The reactor was then cooled down to room temperature and the emulsion discharged. The emulsion comprised 12.6 weight percent resin and 87.4 weight percent water.

Pigment Dispersion. An aqueous dispersion of Blue 15.3 pigment available from Sun Chemicals was employed. The pigment dispersion contained an anionic surfactant and the pigment content of the dispersion supplied was 26.5 percent pigment, 2 percent surfactant, and 71.5 percent water.

Toner preparation. A synthesis of 5.7 micron cyan polyester toner particles was conducted by using 4% by weight calcium chloride solution as flocculants. There was no zinc acetate employed in the process. 409.9 grams of deionized with 955.1 grams polyester latex and 12.1 grams ofPB:15:3 cyan pigment were charged into a 2 liter stainless steel Buchi reactor. The reactor was installed with a mechanical agitator and equipped with a double pitched blade impellors. The mixture was agitated at 300 rpm for 5 minutes. Then the entire content was transferred to reactor and heated to 65° C. Particle growth was monitored during the heat up step. When the reactor temperature reached 65° C., 112.2 grams of aqueous 3% calcium chloride solution comprising 3.37 grams of calcium chloride dissolved in 108.9 grams of water was added at a rate of 1.87 grams per minute over a period of 1 hour. The toner particle size was measured and determined to be 3.0 microns after the completion of the calcium chloride addition. A slower rate of calcium chloride addition followed by adding 48 grams of 3% calcium chloride solution (1.44 grams calcium chloride dissolved in 46.56 grams water) over a period of 2 hours. At the end of the calcium chloride addition, the temperature of the reactor content was raised to 68° C. The particle size was determined to be about 5.5 microns with a GSD of 1.17. The process to about 9 to 10 hours to complete. When the desired toner particle size was obtained, the reactor was cooled to room temperature and the toner slurry was discharged from the reactor. The final solids particles were filtered from the mother liquor, treated by 3 deionized washes at room temperature, and freeze dried. A 5.6 micron cyan polyester particle with a GSD of 1.17 and a smooth potato type morphology was obtained.

### Example 2

Dual Coagulant Toner Process

An amount of 8.5 micron cyan toner particles were prepared by the present in situ process using 150 parts per million (ppm) calcium chloride with 15 % zinc acetate as flocculants. An amount of 124.3 grams of deionized water with 955.1 grams latex, 12.1 grams PB: 15:3 cyan pigment and 3.75 grams of 1 % calcium chloride solution were charged in a 2 liter stainless steel Buchi reactor. The mixture was agitated at 300 revolutions per minute (rpm) for 5 minutes. Then the reactor was heated to about 60° C. to about 64° C. Particle growth was monitored during heating. Toner particle size was checked from time to time. When the reactor temperature reached 60° C., 420 grams of 3% zinc acetate solution was added at a rate of 7 grams per minute for the duration of 1 hour. Meanwhile, the toner particle was about 3 microns. This process step was followed by a slower rate of zinc acetate addition. That is, adding 180 grams of 3% zinc acetate solution over a 2 hour period at a rate of 1.5 grams per minute. At the end of the zinc acetate addition, the particle growth process was monitored until the particle size was about 8.5 microns. Normally, the entire process took about 9 to 10 hours to complete. When the desired toner size was obtained, the reactor was cooled and the contents were discharged. The particles were filtered from the mother liquor and washed 3 times with deionized water at room temperature before drying. 8.4 micron cyan polyester particles having a geometric size distribution (GSD) of about 1.18, a smooth, potato type morphology, and a solids content of about 9 % were produced.

### Example 3

Dual Coagulant Toner Process

An amount of 8.5 micron cyan toner particles were prepared by the present in situ process using 300 ppm calcium chloride with 15% zinc acetate as flocculants. An amount of 124.3 grams of deionized water with 955.1 grams latex, 12.1 grams of PB:15:3 cyan pigment and 1.875 grams 1% calcium chloride solution were charged in a 2 liter stainless steel Buchi reactor. The mixture was agitated at 300 rpm for 5 minutes. The reactor was then heated to about 60° C to about 64° C. Particle growth was monitored during heating. Toner particle size was checked periodically. When the reactor temperature reached 60° C., 420 grams of 3% zinc acetate solution was added at a rate of 7 grams per minute over a period of about 1 hour. Meanwhile, the toner particle size was about 3 microns. This was followed by zinc acetate addition whereby 180 grams of 3% zinc acetate solution was added over a 2 hour period at a rate of about 1.5 grams per minute. At the end of the zinc acetate addition, the particle growth process was monitored until the particle size was about 8.5 microns. The process took about 9 to 10 hours to complete. When the desired toner size was obtained, the reactor was cooled and the content was discharged. The particles were filtered from the mother liquor followed by 3 deionized water washes at room temperature before drying. 8.4 microns cyan polyester particles having a GSD of about 1.19, a smooth potato type morphology, and a solids content of about 9% were obtained.

### Example 4

Control Toner Comprising Cyan Pigment Using 0% CaC12/15% Zinc Acetate

An amount of 8.5 micron control cyan toner particles were prepared using 15% zinc acetate aggregating agent without the use of calcium chloride. 596.8 grams of deionized water with 4584.6 grams latex, 58.0 grams of PB: 15:3 cyan pigment were charged in a 10 liter stainless steel reactor. The mixture was agitated at 180 rpm for 5 minutes. The reactor was then heated to about 60° C. to about 64° C. Particle growth was monitored during heating. Toner particle size was checked periodically. When the reactor temperature reached 62° C., 2020.2 grams of 3% zinc acetate solution was added at a rate of 33.6 grams per minute over a period of about 1 hour. Meanwhile, the toner particle size was about 3.6 microns. This FIZA step was followed by a slower rate of zinc acetate addition whereby 865.8 grams of 3% zinc acetate solution was added over a 2 hour period at a rate of about 7.2 grams per minute. At the end of the zinc acetate addition, the particle growth process was monitored until the particle size was about 8.5 microns. The process took about 9 to 10 hours to complete. When the desired toner size was obtained, the reactor was cooled and the content was discharged. The particles were filtered from the mother liquor followed by 3 deionized water washes at room temperature before drying. 8.5 microns cyan polyester particles having the charging characteristics shown in the Table below were obtained.

Charging data for Examples 1-4 are shown in the Table below.

TABLE

| | Q/m CZ-20 | Q/m BZ-20 | RH |
|---|---|---|---|
| Toner Example | min | min | Sensitivity |
| Toner 1: 4% CaCl2as coagulant | −81.5 | −35.7 | 2.3 |
| Toner 2: Cyan/150 ppmCaCl₂ | −61.25 | −22.6 | 2.7 |
| in-situ | | | |
| Toner 3: 300 ppm CaCl₂ in-situ | −54 | −34.3 | 1.6 |
| Toner 4: Cyan/Control - | −111.2 | −83.6 | 1.33 |
| Zinc acetate only/No CaCl₂ | | | |

* wherein
Q/m = charge to mass ratio of the developed toner, in microCoulombs per gram (Q/m), measured by total blow off using a Faraday cage
CZ = C Zone (15% RH and 10° Celsius)
BZ = B Zone (50% RH and 22° Celsius)
RH = relative humidity

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A dual coagulant toner process comprising:
adding a first component comprising an ionic salt to a latex emulsion of resin having a colorant mixed therein, to form a latex emulsion;
adding a second component comprising an organo-metallic aggregating agent to the latex emulsion by agitation at a temperature above a glass transition temperature of the resin, thereby forming a product mixture;
subsequently cooling the product mixture to a temperature below the glass transition temperature of the resin, in order to form toner particles; and
optionally, isolating the toner particles.

2. The dual coagulant toner process of claim 1, further comprising:
a release agent.

3. The dual coagulant toner process of claim 1, further comprising:
a release agent selected from the group consisting of a wax, an alkylene wax, a polyethylene wax, a polypropylene wax, a paraffin wax, a microcrystalline wax, a Fischer-Tropsch wax, or a mixture thereof.

4. The dual coagulant toner process of claim 1, wherein the first component is an ionic salt selected in an amount of about 0.01 to about 5 percent by weight based upon the total weight of the toner.

5. The dual coagulant toner process of claim 1, wherein the first component is an ionic salt selected in an amount of about 0.01 % to about 0.1 % by weight based upon the total weight of the toner particles.

6. The dual coagulant toner process of claim 1, wherein the first component is an ionic salt selected from the group consisting of sulfate ionic salts, phosphate ionic salts, and chloride ionic salts.

7. The dual coagulant toner process of claim 1, wherein the first component is a divalent salt.

8. The dual coagulant toner process of claim 7, wherein the divalent salt is selected from the group consisting of zinc sulfate, calcium sulfate, aluminum sulfate, barium sulfate, cesium sulfate, sodium sulfate, zirconium sulfate, zinc phosphate, calcium phosphate, aluminum phosphate, barium phosphate, cesium phosphate, sodium phosphate, zirconium phosphate, zinc chloride, calcium chloride, aluminum chloride, barium chloride, cesium chloride, sodium chloride, zirconium chloride, and mixtures thereof

9. The dual coagulant toner process of claim 1, wherein the second component comprises an organo-metallic aggregating agent selected in an amount of about 1 to about 20 percent by weight based upon the total weight of the toner particles.

10. The dual coagulant toner process of claim 1, wherein the second component comprises an organo-metallic aggregating agent selected in an amount of about 3 to about 15 percent by weight based upon the total weight of the toner particles.

11. The dual coagulant toner process of claim 1, wherein the second component comprises an organo-metallic aggregating selected from the group consisting of alkali earth metal salt organo-metallic aggregating agents and transition metal salt organo-metallic aggregating agents.

12. The dual coagulant toner process of claim 1, wherein the second component comprises an organo-metallic aggregating agent selected from the group consisting of magnesium acetate, strontium acetate, vanadium acetate, niobium acetate, tantalum acetate, chromium acetate, molybdenum acetate, tungsten acetate, manganese acetate, iron acetate, ruthenium acetate, cobalt acetate, nickel acetate, copper acetate, zinc acetate, cadmium acetate, silver acetate, aluminum acetate, vanadium acetoacetate, niobium acetoacetate, tantalum acetoacetate, chromium acetoacetate, molybdenum acetoacetate, tungsten acetoacetate, manganese acetoacetate, iron acetoacetate , ruthenium acetoacetate, cobalt acetoacetate, nickel acetoacetate, copper acetoacetate, zinc acetoacetate, cadmium acetoacetate, silver acetoacetate, aluminum acetoacetate, and mixtures thereof.

13. The dual coagulant toner process of claim 1, wherein the second component is zinc acetate.

14. The dual coagulant toner process of claim 1, wherein the resin comprises a polyester or a sulfonated polyester.

15. The dual coagulant toner process of claim 1, wherein the resin is selected from the group consisting of sulfonated polyester, sodium sulfonated polyester, poly(1,2-propylene-sodio-5-sulfoisophthalate), poly(neopentylene-sodio-5-sulfoisophthalate), poly(diethylene-sodio-5-sulfoisophthalate), copoly(1,2-propylene-sodio-5-sulfoisophthalate)-copoly-(1, 2-propylene-terephthalate-phthalate), copoly(1,2-propylene-diethylene-sodio-5-sulfoisophthalate)-copoly-(1,2-propylene-diethylene-terephthalate-phthalate), copoly(ethylene-neopentylene-sodio-5-sulfolsophthalate)-copoly-(ethylene-neopentylene-terephthalate-phthalate), copoly(propoxylated bisphenol A)-copoly-(propoxylated bisphenol A-sodio-5-sulfoisophthalate), and mixtures thereof.

16. The dual coagulant toner process of claim 1, wherein the colorant comprises a dye, a pigment, mixtures of dyes, mixtures of pigments, mixtures of pigments and dyes, or a pigment dispersion.

17. A process for preparing a developer comprising:
preparing a toner composition using the dual coagulant toner process of claim 1; and
mixing the resulting toner composition with a carrier.

18. A single coagulant toner process comprising:
(i) heating a resin in water at a temperature above a glass transition temperature of the resin to form a latex emulsion of resin;
(ii) providing a colorant dispersion or preparing a colorant dispersion by dispersing a colorant in water to form a colorant dispersion;
(iii) adding the colorant dispersion of (ii) to the latex emulsion of (i) with agitation to form particles;
(iv) growing particles formed in (iii) at an elevated temperature, and adding a single coagulating/aggregating component comprising an ionic salt by agitation during the growing to form a product mixture;
(v) subsequently cooling the product mixture obtained to a temperature below the glass transition temperature of the resin to form toner particles; and
(vi) optionally, isolating the toner particles.

19. The single coagulant toner process of claim 18, wherein the single coagulating/aggregating agent is an ionic salt selected from the group consisting of sulfate ionic salts, phosphate ionic salts, and chloride ionic salts.

20. The single coagulant toner process of claim 18, wherein the single coagulating/aggregating agent is a divalent salt.

21. The single coagulant toner process of claim 20, wherein the divalent salt is selected from the group consisting of zinc sulfate, calcium sulfate, aluminum sulfate, barium sulfate, cesium sulfate, sodium sulfate, zirconium sulfate, zinc phosphate, calcium phosphate, aluminum phosphate, barium phosphate, cesium phosphate, sodium phosphate, zirconium phosphate, zinc chloride, calcium chloride, aluminum chloride, barium chloride, cesium chloride, sodium chloride, zirconium chloride, and mixtures thereof.

22. The single coagulant toner process of claim 18, wherein the resin comprises a polyester or a sulfonated polyester.

23. The single coagulant toner process of claim 18, wherein the resin is selected from the group consisting of sulfonated polyester, sodium sulfonated polyester, poly(1,2-propylene-sodio-5-sulfoisophthalate), poly(neopentylene-sodio-5-sulfoisophthalate), poly(diethylene-sodio-5-sulfoisophthalate), copoly(1,2-propylene-sodio-5-sulfoisophthalate)-copoly-(1,2-prolylene-terephthalate-phthalate), copoly (1,2-propylene-diethylene-sodio-5-sulfoisophthalate)-copoly-(1,2-propylene-diethylene-terephthalate-phthalate), copoly (ethylene-neopentylene-sodio-5-sulfoisophthalate)-copoly-(ethylene-neopentylene-terephthalate-phthalate), copoly(propoxylated bisphenol A)-copoly-(propoxylated bisphenol A-sodio-5-sulfoisophthalate), and mixtures thereof.

24. The single coagulant toner process of claim 18, wherein the colorant comprises a dye, a pigment, mixtures of dyes, mixtures of pigments, mixtures of pigments and dyes, or a pigment dispersion.

25. A process for preparing a developer comprising:
preparing a toner composition with the single coagulant toner process of claim 18; and
mixing the resulting toner composition with a carrier.

26. A dual coagulant toner process comprising:
adding an organo-metallic aggregating agent to a latex emulsion of polyester resin having a colorant mixed therein to form a polyester latex emulsion;
adding an ionic salt to the polyester latex emulsion by agitating at a temperature above a glass transition temperature of the polyester resin to form a product mixture;
subsequently cooling said product mixture to a temperature below the glass transition temperature of the polyester resin to form toner particles; and
optionally, isolating the toner particles.
